(19) United States
(12) Patent Application Publication
(10) Pub. No.: US 2015/0292662 A1
(43) Pub. Date: Oct. 15, 2015

(54) Rough-In Adapter Cover and Assembly

(71) Applicant: Zum Industries, LLC, Erie, PA (US)

(72) Inventors: Christopher A. Majocka, Erie, PA (US); Douglas R. Wroblewski, Erie, PA (US); William A. Verdecchia, Erie, PA (US); Patrick Slater, Findley Lake, NY (US); Robert Diplacido, Erie, PA (US)

(73) Assignee: Zum Industries, LLC, Erie, PA (US)

(21) Appl. No.: 14/252,356

(22) Filed: Apr. 14, 2014

(51) Int. Cl. F16L 35/00

(52) U.S. Cl. CPC F16L 35/00

(57) ABSTRACT

A drain assembly includes a drain body connected to a drain pipe such that the drain body is in fluid communication with the drain pipe and a cover that is operatively connected to the drain body in a position over the drain body. The cover is configured to at least partially define a void in a poured concrete slab over the drain body. The cover includes a top, a bottom, and at least one perimetrical sidewall that defines at least one perimetrical surface of the cover. At least one layer of a release material is applied to the at least one perimetrical surface of the cover to prevent poured concrete from adhering to the cover. The bottom of the cover includes a non-threaded attachment mechanism for operatively connecting the cover to the drain body.

### CROSS REFERENCE TO RELATED APPLICATION

The present application is related to co-pending U.S. Patent Application No. 14/067,036, filed on Oct. 30, 2013, which is incorporated herein by reference in its entirety.

### BACKGROUND OF THE INVENTION

1. Field of the Invention

The present invention relates to a drain assembly for installation in a finished floor surface. More particularly, the present invention relates to an adjustable drain assembly that is configured to allow for positioning of a strainer at the same level of the finished floor surface at the time of installation.

2. Description of Related Art

Typical drain assemblies or drain fixtures are installed in a finished floor surface, such as a finished concrete floor or a tiled floor, to drain water or other liquids from a top surface of the floor and allow the liquid to flow into an underlying drain pipe. Typical drain assemblies include a drain body connected to the drain pipe and a drain head connected to the drain body. The drain head may include a grate or strainer at the top thereof to prevent large pieces of debris from entering and clogging the drain pipe.

The drain head typically includes a threaded portion that is threadably attached to the drain body or directly to the drain pipe. The height of the drain head may be minimally adjusted up or down by threading the drain head further into or out of the drain body or drain pipe.

During installation, the drain body and drain head are installed upon the drain pipe prior to pouring the surrounding concrete slab that defines the primary floor surface. Ideally, the drain is installed at the proper height to allow for proper drainage and so that the strainer or grate will be positioned flush with the final floor surface, i.e., at the same level as the finished concrete flooring or with any supplemental flooring, such as tiles, installed on top of the concrete slab. Because the drain body and the drain head must be installed prior to construction of the finished flooring, the drain assembly is subject to infiltration by debris, which requires cleaning after completion of the flooring, and damage during construction.

Further, once the finished concrete slab is constructed and set, it is usually impossible to raise or lower the level of the drain head and/or strainer without removing finished concrete from the area of the drain assembly.

One solution to the above-identified problems is provided by the above-identified U.S. patent application Ser. No. 14/067,036, which discloses a drain assembly for installation in a finished floor surface that includes a rough-in cover that is connected to a portion of the drain head of the drain assembly during pouring of a concrete slab around the drain assembly to define a void in the poured concrete slab around the drain head to allow for adjustment of the drain head to be level with the finished floor surface. However, as the poured concrete slab cures around the rough-in cover, there is a potential that the cured concrete will adhere or become stuck to the cover. When this occurs, removing the rough-in cover from the assembly and the concrete slab to open the void can become difficult and may result in damage to the poured concrete slab, which could necessitate repairs to the slab prior to installation of the finished floor surface.

### SUMMARY OF THE INVENTION

Accordingly, there is a general need in the art for a drain assembly that allows for a void to be created in a finished concrete slab to allow for installation of a drain head after completion of the concrete slab so that the height of the drain head can be easily adjusted both during and after installation. There is also a general need in the art for a drain head that allows for easy installation of different strainers or grates on a drain assembly during and after installation. There is, additionally, a general need in the art for a rough-in cover for use during installation of a drain assembly that can be easily removed from a cured concrete slab without resulting in damage to the concrete slab.

According to one particular embodiment of the invention, a drain assembly is provided. The drain assembly includes a drain body configured to be connected to a drain pipe such that the drain body is in fluid communication with the drain pipe, and a cover configured to be operatively connected to the drain body in a position over the drain body and to at least partially define a void in a poured concrete slab over the drain body. The cover includes a top, a bottom, and at least one perimetrical sidewall that defines at least one perimetrical surface of the cover. At least one layer of a release material is applied to the at least one perimetrical surface of the cover to prevent poured concrete from adhering to the cover. The bottom of the cover includes a non-threaded attachment mechanism for operatively connecting the cover to the drain body.

According to another particular embodiment of the invention, a rough-in cover for a drain assembly is provided. The rough-in cover includes a top, a bottom, and at least one perimetrical sidewall that defines at least one perimetrical surface of the cover, at least one layer of a release material applied to the at least one perimetrical surface of the cover, and a non-threaded attachment mechanism for removably connecting the cover to a portion of the drain assembly. The cover is configured to be positioned over the drain assembly and to at least partially define a void in a poured concrete slab over the drain assembly. The at least one layer of release material is adapted to prevent poured concrete from adhering to the cover.

According to yet another particular embodiment of the invention, a method of installing a drain assembly in a finished floor surface is provided. The method includes providing a drain assembly. The drain assembly includes a drain body and a cover configured to be operatively connected to the drain body in a position over the drain body. The method further includes operatively connecting the cover to the drain body in the position over the drain body, connecting the drain body to a drain pipe such that the drain body is in fluid communication with the drain pipe, pouring a concrete slab around the cover and over the drain body such that the cover at least partially defines a void in the poured concrete slab over the drain body, and removing the cover from the operative connection with the drain body. The cover includes a top, a bottom, and at least one perimetrical sidewall that defines at least one perimetrical surface of the cover, and at least one layer of a release material is applied to the at least one perimetrical surface of the cover to prevent the poured concrete from adhering to the cover. The bottom of the cover includes a non-threaded attachment mechanism for operatively connecting the cover to the drain body.

Further details and advantages of the invention will become clear upon reading the following detailed description in conjunction with the accompanying drawing figures, wherein like parts are designated with like reference numerals throughout.

### BRIEF DESCRIPTION OF THE DRAWINGS

FIG. 1 is an exploded perspective view of a drain assembly in accordance with an embodiment of the present invention;

FIG. 2 is another exploded perspective view of the drain assembly of FIG. 1;

FIG. 3 is an exploded view of the lower frame and the shank of the drain assembly of FIG. 1;

FIGS. 4A, 4B, and 4C are a series of views illustrating the engagement between the lower frame and the shank of the drain assembly of FIG. 1;

FIGS. 4D-4M are a series of views illustrating an alternative embodiment of a lower frame of the drain assembly of FIG. 1 and illustrating the engagement between the lower frame and the shank of the drain assembly of FIG. 1;

FIG. 5 is a perspective view of the shank and the drain body of the drain assembly of FIG. 1;

FIG. 6 is a schematic representation illustrating the installation of the drain assembly of FIG. 1 in a finished floor surface;

FIG. 7 is a cross-sectional perspective view of a cover assembly in accordance with another embodiment of the present invention connected to the shank and drain body of the drain assembly of FIG. 1;

FIG. 8 is a cross-sectional side view of the cover assembly of FIG. 7 connected to the shank and drain body of the drain assembly of FIG. 1;

FIG. 8A is a cross-sectional side view of the cover assembly of FIG. 7 according to an alternative embodiment of the present invention connected to the shank and drain body of the drain assembly of FIG. 1;

FIG. 9 is a top view of a cover of the cover assembly of FIG. 7;

FIG. 10 is a bottom view of the cover of the cover assembly of FIG. 7;

FIG. 11 is a cross-sectional side view of the cover of the cover assembly of FIG. 7 taken along lines 11-11 shown in FIG. 9;

FIG. 12 is an enlarged bottom perspective view of a portion of the cover of the cover assembly of FIG. 7;

FIG. 13 is a top view of a cover of a cover assembly in accordance with another embodiment of the present invention;

FIG. 14 is a side view of the cover of FIG. 13 connected to the shank of the drain assembly of FIG. 1 having a protector sleeve positioned thereon;

FIG. 15 is a lower perspective view of the cover of FIG. 13 connected to the shank of the drain assembly of FIG. 1 having a protector sleeve positioned thereon;

FIG. 16 is a lower perspective view of the cover of FIG. 13 according to an alternative embodiment of the present invention connected to the shank of the drain assembly of FIG. 1 having a protector sleeve positioned thereon;

FIG. 17 is a top view of a cover of a cover assembly in accordance with another embodiment of the present invention;

FIG. 18 is a side view of the cover of FIG. 17 connected to the shank of the drain assembly of FIG. 1 having a protector sleeve positioned thereon;

FIG. 19 is a lower perspective view of the cover of FIG. 17 connected to the shank of the drain assembly of FIG. 1 having a protector sleeve positioned thereon; and

FIG. 20 is a lower perspective view of the cover of FIG. 17 according to an alternative embodiment of the present invention connected to the shank of the drain assembly of FIG. 1 having a protector sleeve positioned thereon.

### DETAILED DESCRIPTION OF THE INVENTION

For purposes of the description hereinafter, spatial orientation terms, if used, shall relate to the referenced embodiment as it is oriented in the accompanying drawing figures or otherwise described in the following detailed description. However, it is to be understood that the embodiments described hereinafter may assume many alternative variations and embodiments. It is also to be understood that the specific devices illustrated in the accompanying drawing figures and described herein are simply exemplary and should not be considered as limiting.

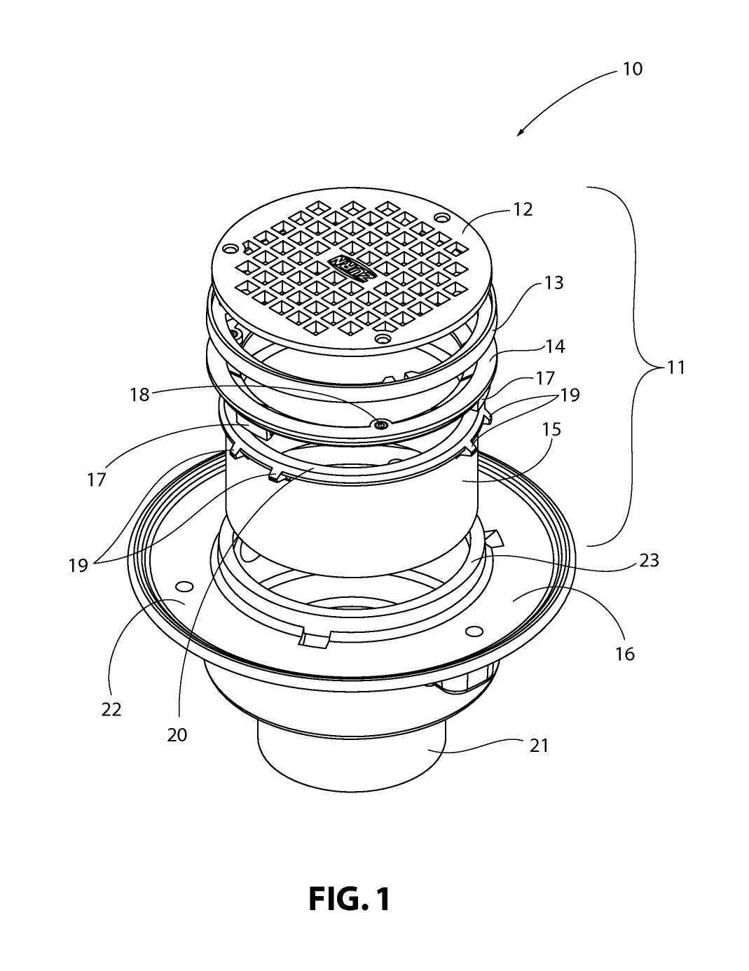

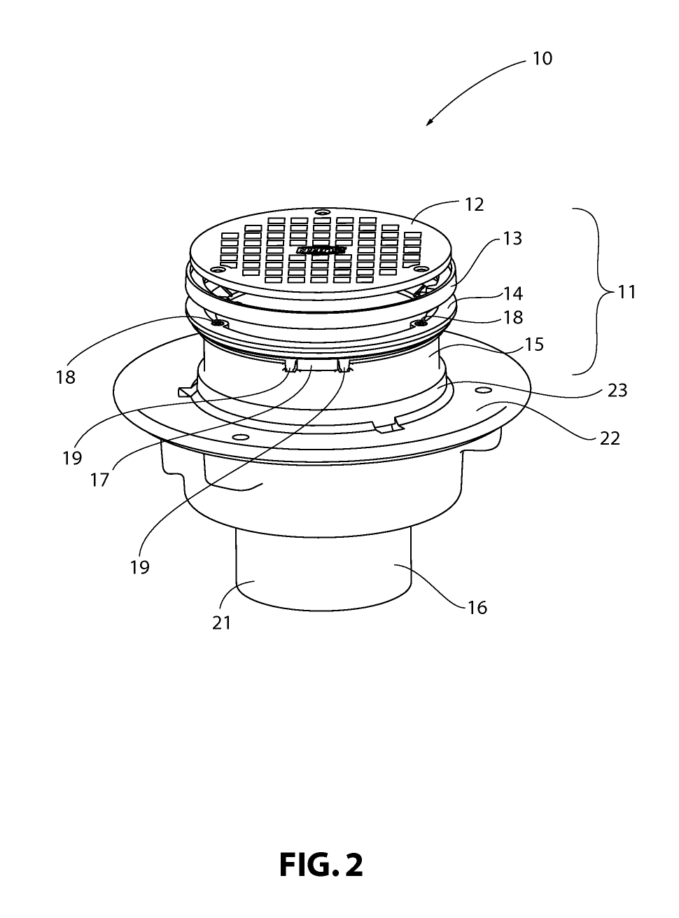

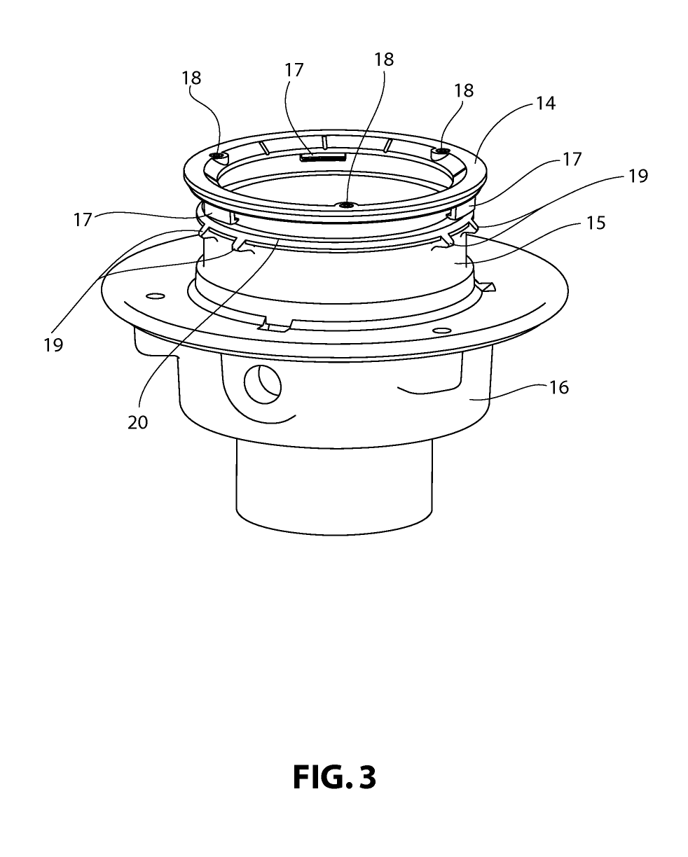

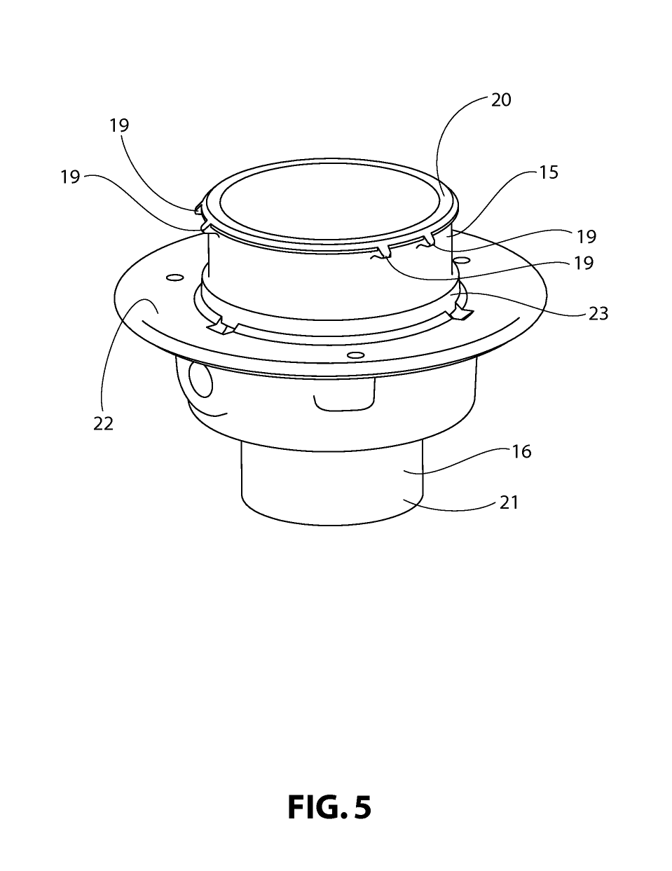

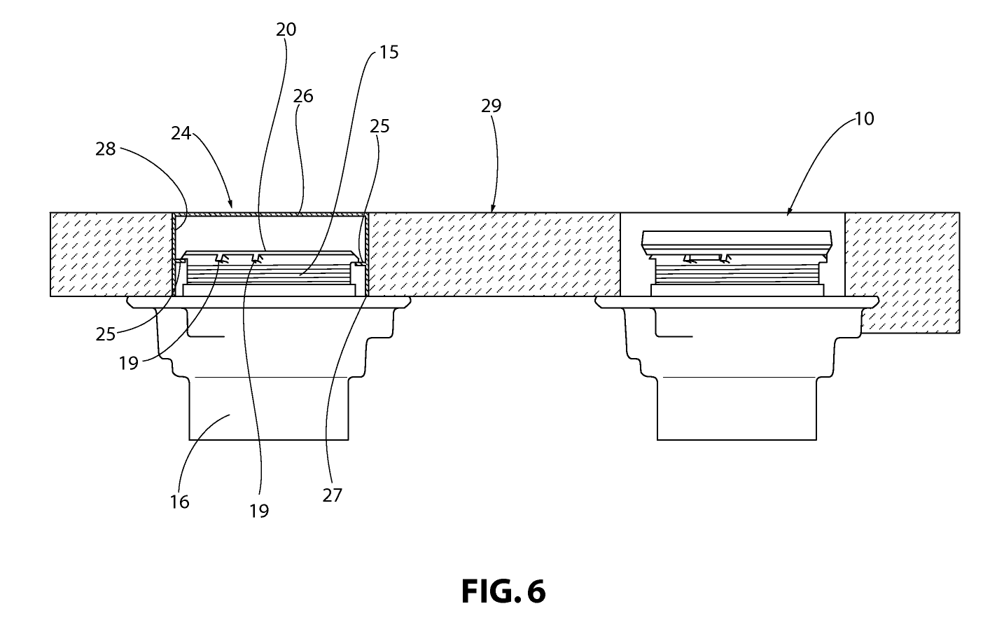

With reference to FIGS. 1-4C and 5, a drain assembly 10 for installation in a finished floor surface 29 is shown in accordance with an embodiment of the present invention. As shown in FIGS. 1 and 2, the drain assembly 10 includes a drain head assembly 11 adjustably connected to a drain body 16. The drain head assembly 11 includes a shank 15 and a strainer assembly that includes a strainer 12, an upper frame 13, and a lower frame 14 connected to the shank 15. The strainer 12 and upper frame 13 may be constructed of metal, with the strainer 12 being positioned inside the upper frame 13. The lower frame 14 may be constructed of a plastic material. The shank 15 may be constructed from plastic or cast iron material. When assembled, the upper frame 13 will rest on the top surface of the lower frame 14, and the strainer 12, upper frame 13, and lower frame 14 are secured to each other by fasteners, such as machine screws, that are inserted through the strainer 12 and the upper frame 13, and threaded into the lower frame 14. To that end, the lower frame 14 includes threaded holes 18 extending therethrough. The threaded holes 18 may be directly formed in the lower frame 14 or may be inserts made from a durable material, such as metal, that are molded into the lower frame 14. As can be appreciated by one having ordinary skill in the art, the strainer 12, upper frame 13, and lower frame 14 may also be secured to each other by any suitable means, other than machine screws and threads.

The strainer assembly is fastened together and shipped as a single unit, and then assembled onto the drain assembly 10 during installation. It is to be appreciated that the strainer 12, upper frame 13, lower frame 14, and the shank 15 may be made from any material(s) known to be suitable to those having ordinary skill in the art. Also, various configurations in the assembly of the strainer assembly are also possible. For instance, the upper frame 13 and the lower frame 14 may be combined into a single piece, with the strainer 12 fastened to the single frame piece.

As shown in FIGS. 1-4C, the lower frame 14 includes a connection feature that allows the lower frame 14 and, thus, the entire strainer assembly to be non-threadably connected to a top end of the shank 15 to allow for easy assembly and removal of the strainer assembly from the shank 15. In particular, the lower frame 14 includes at least two, and particularly three, equally circumferentially-spaced snap-on hooks 17 extending from a bottom surface of the lower frame 14. The shank 15 includes at least two, and particularly three, complementary sets of lugs 19 at a top end thereof extending outward from a top ring 20 of the shank 15. When the strainer assembly is assembled onto the shank 15, the lower frame 14 is pressed down over the top surface of the shank 15 until the hooks 17 grab on to the top ring 20 formed at the top end of the shank 15 by bending outward and snapping over and onto the top end of the shank 15. Each set of lugs 19 engages a respective one of the flexible hooks 17. The lugs 19 are provided so that, when the lower frame 14 is assembled onto the threaded shank 15, the hooks 17 may be positioned between the lugs 19 to prevent rotation of the lower frame 14 and the strainer assembly with respect to the threaded shank 15.

Accordingly, it is to be appreciated that a variety of shapes and configurations of the strainer 12, upper frame 13, and lower frame 14 may be provided and used with a common or standard threaded shank 15 since the lower frame 14 is connected to the top end of the threaded shank 15 without the use of fasteners or other specialized hardware. In particular, the top flange geometry of the lower frame 14 may be molded into a plurality of sizes and configurations to accommodate a variety of strainers 12 and upper frames 13. For instance, the lower frame 14 can be molded into various shapes, such as round or square, and into a variety of sizes to accommodate various finished assemblies of strainers 12 and upper frames 13. Thus, the threaded shank 15 may be made standard and compatible with a variety of different configurations of the strainer assembly. Further, the threaded shank 15 may be replaced or reused without requiring replacement or reuse of a strainer assembly, and vice versa.

It is to be appreciated that the connection feature that allows for assembly of the lower frame 14 onto the threaded shank 15 may be of any configuration known to be suitable to those having ordinary skill in the art. According to an alternative embodiment of the present invention, the connection feature is a bayonet-type attachment mechanism, wherein one of the lower frame 14 or the threaded shank 15 includes lugs that engage within a circumferential groove formed in the other of the lower frame 14 or the threaded shank 15.

As shown in FIGS. 1, 2, and 5, the drain body 16 includes a bottom outlet 21 that connects to a drain pipe (not shown), such that the drain body 16 is in fluid communication with the drain pipe, and a lid 22 fastened to the outlet 21 in a standard configuration. The drain body 16 may be made from plastic or cast iron or other suitable materials. The lid 22 includes a protruding horn 23 thereon that has female threads on an inside surface thereof. The shank 15 includes external male threads on an outside surface thereof, such that the shank 15 may be threadably and adjustably connected to the drain body 16, such that the drain head assembly 11 is in fluid communication with the drain body 16 and installed to the required height with respect to the drain body 16 and the finished floor surface. It is to be appreciated that the shank 15 may be adjustably connected to the drain body 16 by suitable means other than a threaded connection. For instance, the shank 15 may be slidably connected to the drain body 16 and then locked in a vertical position by a suitable mechanism, or the shank 15 may include a plurality of notched steps that rest on lugs formed within an interior diameter of the drain body 16.

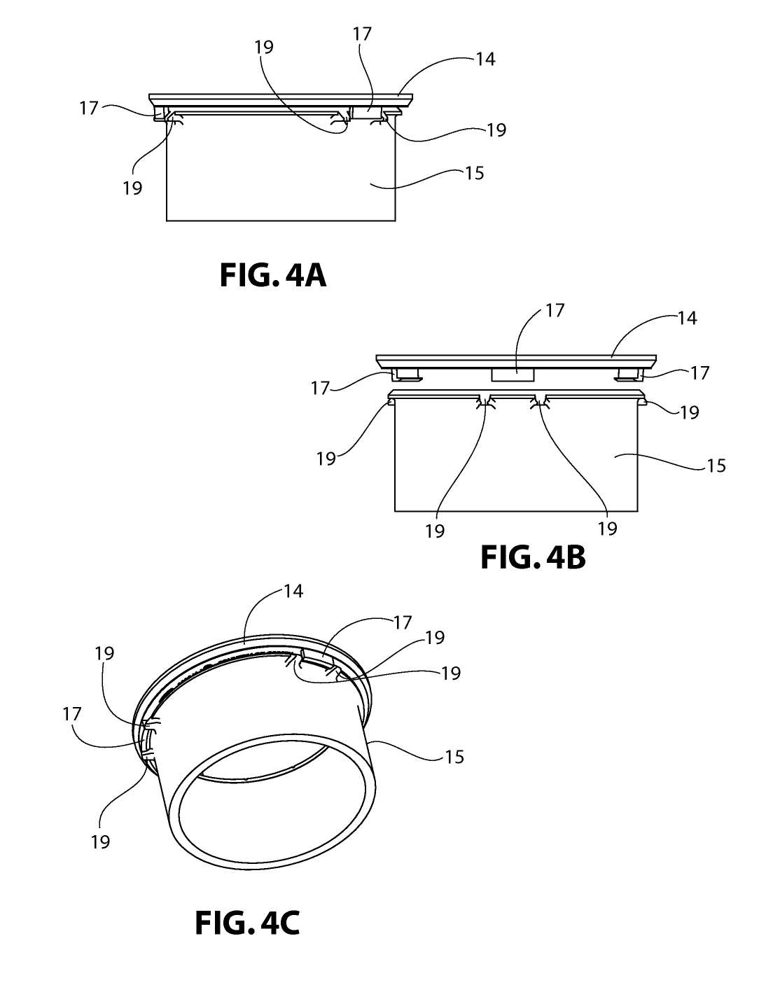

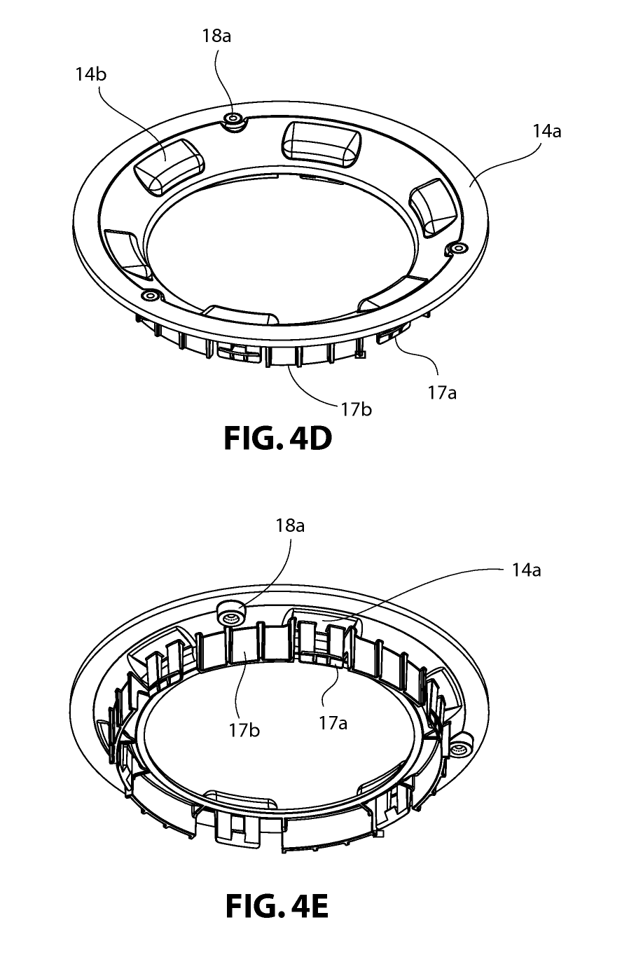

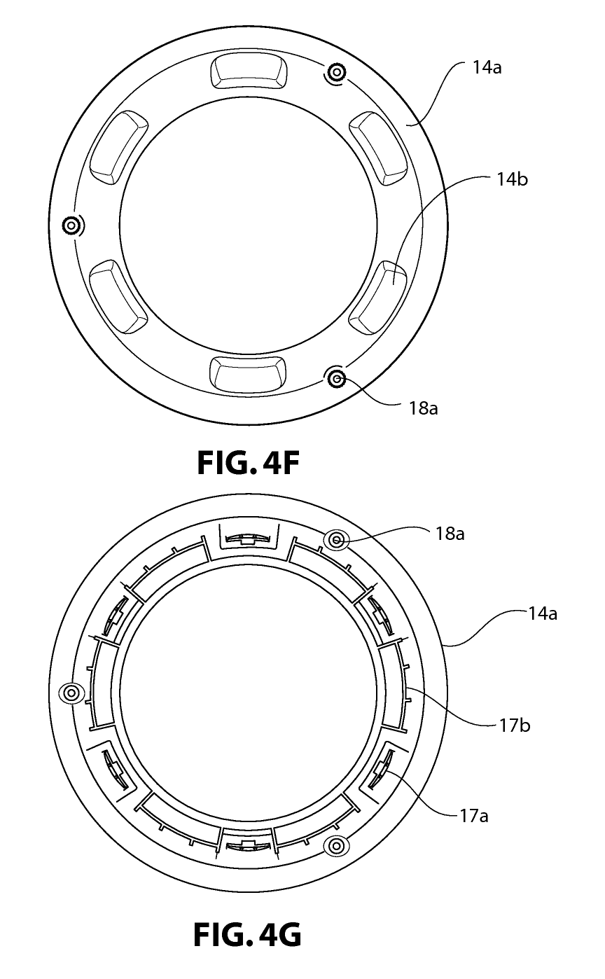

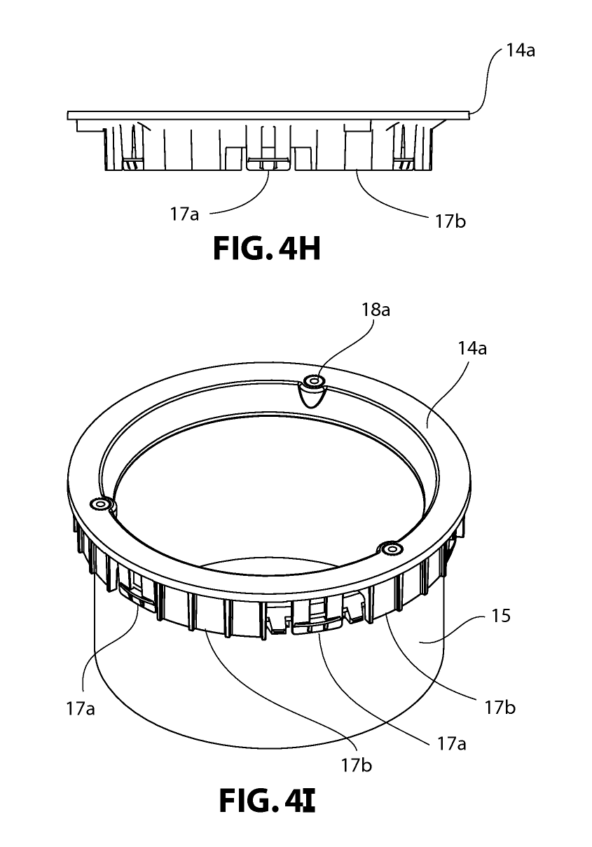

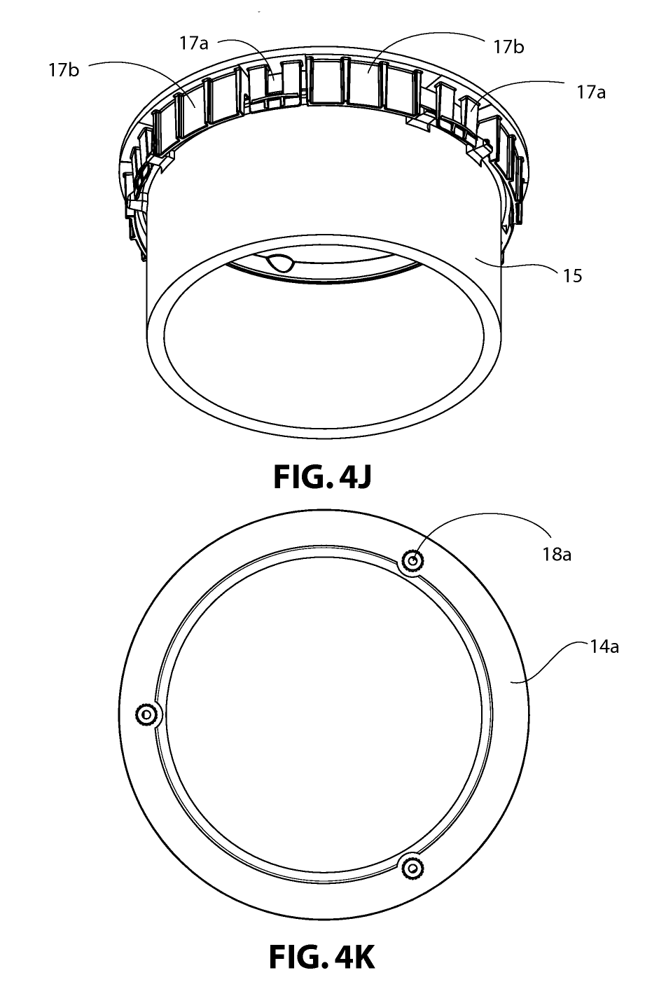

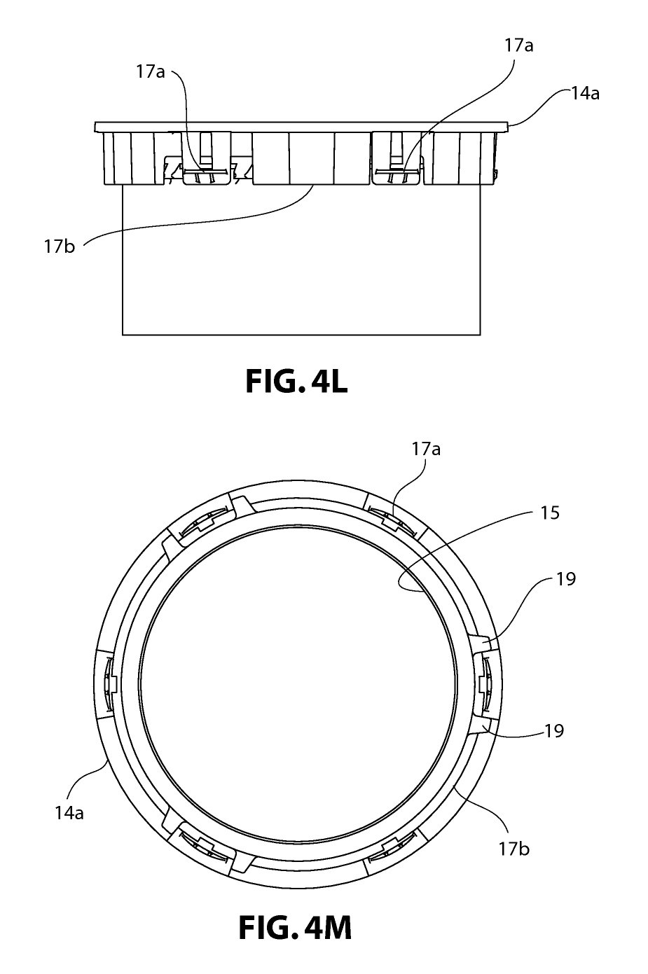

With reference to FIGS. 4D-4M, an alternative embodiment of a lower frame 14a is shown. The lower frame 14a includes six circumferentially-spaced, flexible snap hooks 17a extending from a bottom surface of the lower frame 14a. The flexible snap hooks 17a are interspaced by circumferential walls 17b that also extend from the bottom surface of the lower frame 14a. The flexible snap hooks 17a are lengthened in comparison to the snap hooks 17 discussed above with reference to FIGS. 1-4C in order to provide greater flexibility. The circumferential walls 17b extend a similar length as the flexible snap hooks 17a. The provision of six snap hooks 17a to the lower frame 14a results in additional pull force resistance being provided to the lower frame 14a. Three of the hooks 17a engage the top ring 20 of the shank 15 within the lugs 19 to prevent rotation of the lower frame 14a, as discussed above. The other three snap hooks 17a engage the top ring 20 of the shank 15 for additional support.

As shown in FIGS. 4I-4M, the top ring 20 of the shank 15 fits within the perimeter defined by the snap hooks 17a and the circumferential walls 17b. In this manner, the circumferential walls 17b are positioned to resist shear force applied to the snap hooks 17a that may occur during usage and prevent forces from being applied to and damaging or breaking the snap hooks 17a. The snap hooks 17a may also include reinforcement ribs to prevent breakage. Protruding bumps 14b may be formed in the lower frame 14a in order to promote making the snap hooks 17a with a longer length. The bumps 14b may be configured to have a tapered surface to prevent standing water from collecting on the lower frame 14a. The lower frame 14a is installed on the shank 15 in the same manner as discussed above with respect to the lower frame 14. The lower frame 14a also includes threaded holes 18a to allow the upper frame 13 and strainer 12 to be fastened to the lower frame 14a, also in the same manner as discussed above.

With reference to FIG. 6, the drain assembly 10 is installed in a finished floor surface 29 with the aid of a rough-in cover 24. As shown, during construction, the drain body 16 and the threaded shank 15 are connected to the drain pipe within the subflooring. The rough-in cover 24 is then positioned on the drain body 16 and over the shank 15 such that a bottom 27 of the cover 24 is in engagement with the lid 22 of the drain body 16, and the threaded shank 15 is within an interior of the cover 24. The cover 24 includes hooks 25 or other features extending from an interior surface 28 thereof that engage the top of the shank 15 to removably connect the cover 24 to the shank 15 in the same manner as the lower frame 14 discussed above. Thus, the threaded shank 15 and the rough-in cover 24 can be installed on to the drain body 16 and then adjusted to the required height, such that a top surface 26 of the rough-in cover 24 is positioned at a level flush with the intended height of the finished floor surface 29. The concrete slab can then be poured around the cover 24 and over the drain body 16, such that the cover 24 at least partially defines a void in a poured concrete slab of the finished floor surface 29 that allows for installation and adjustment of the drain head assembly 11. In particular, because the cover 24 is positioned over and surrounds the shank 15 and extends to engage the lid 22 of the drain body 16, the cover 24 fully defines the void. To that end, an expansible sealing material (not shown) may be provided between the bottom 27 of the cover 24 and the lid 22 of the drain body 16 to prevent infiltration of poured concrete material therebetween during the pour.

Once the concrete slab is poured and the finished floor surface 29 completed, the rough-in cover 24 can be removed from the shank 15, which remains adjustable with respect to the drain body 16, and the strainer assembly of the strainer 12, upper frame 13, and lower frame 14 can be connected to the top of the threaded shank 15 in the manner discussed above. The drain head assembly 11 can be adjusted to the proper height such that the strainer 12 is flush with the finished floor surface 29.

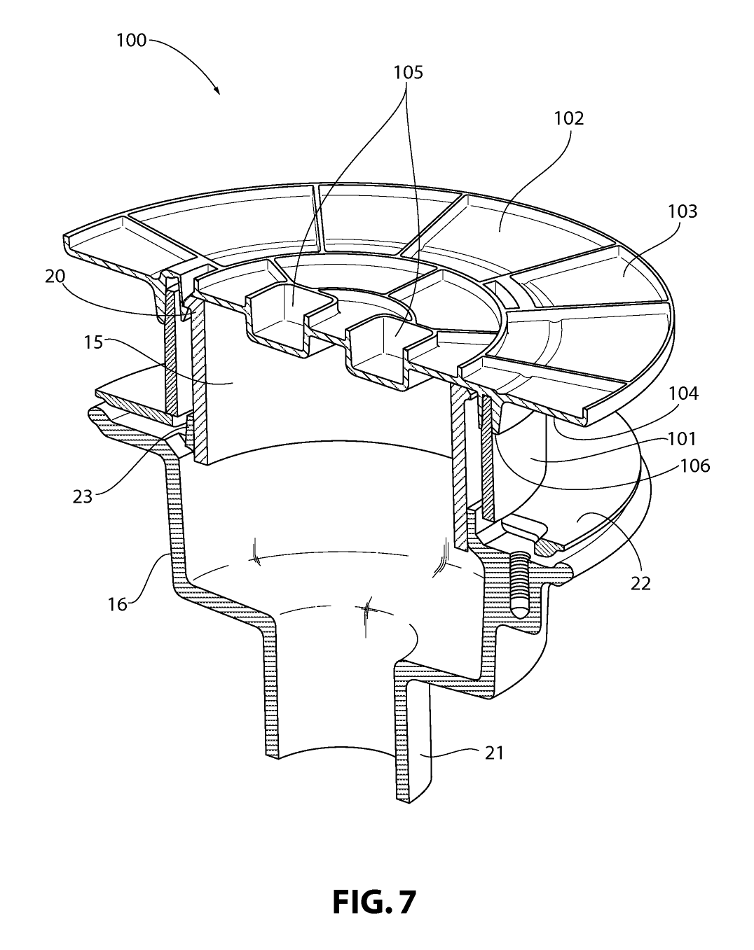

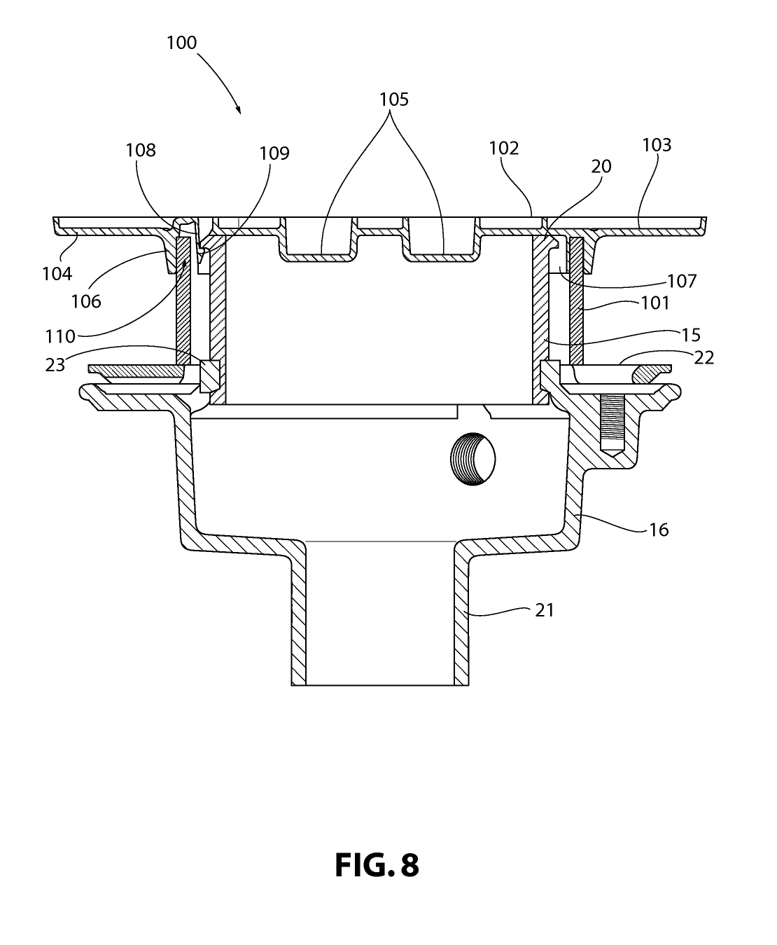

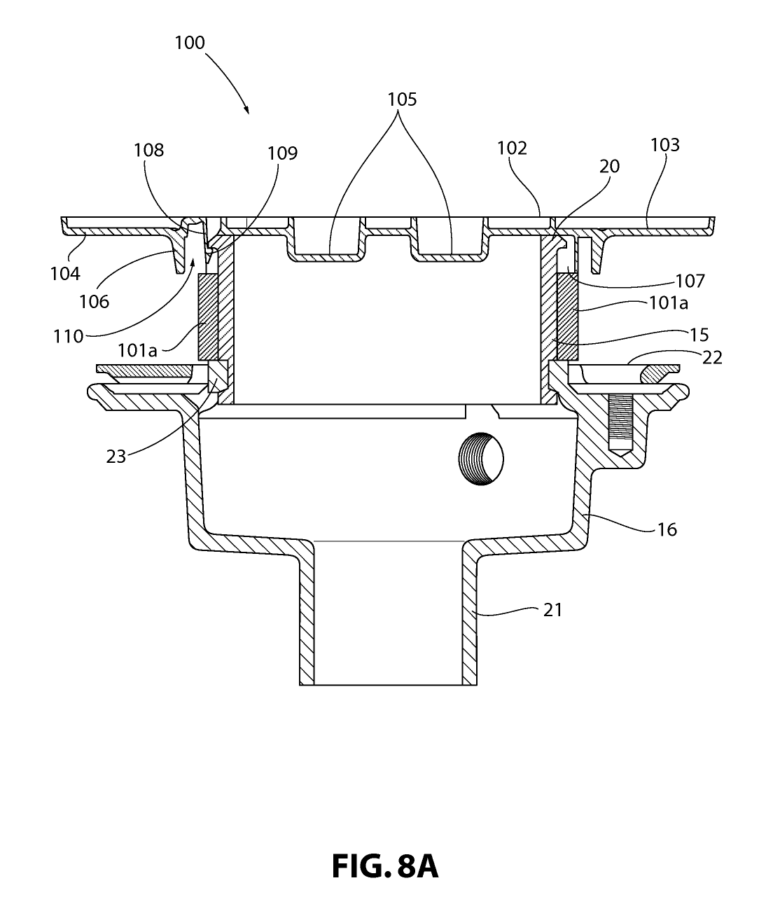

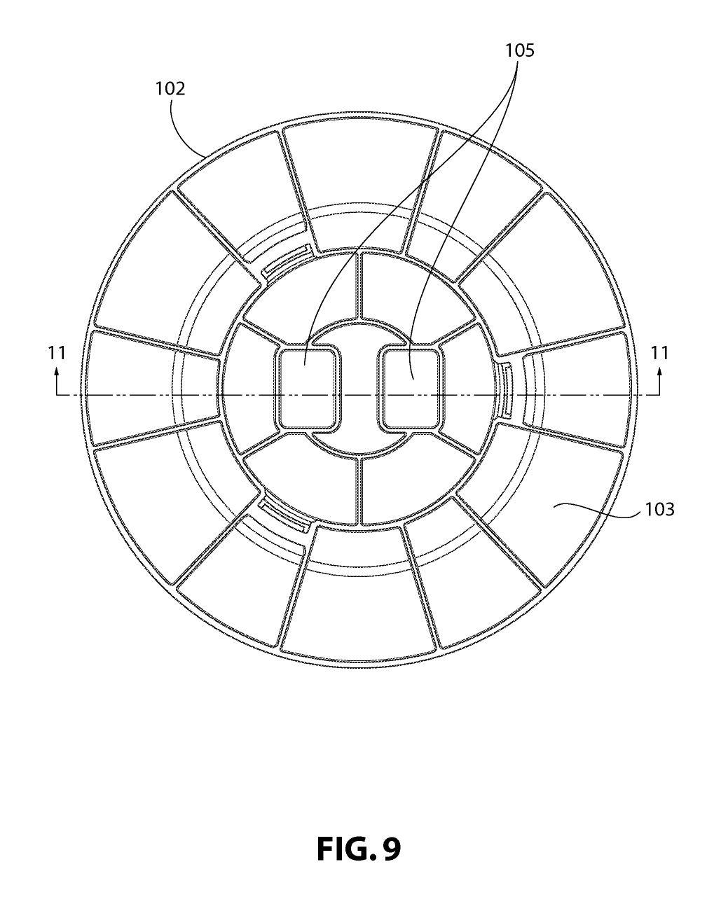

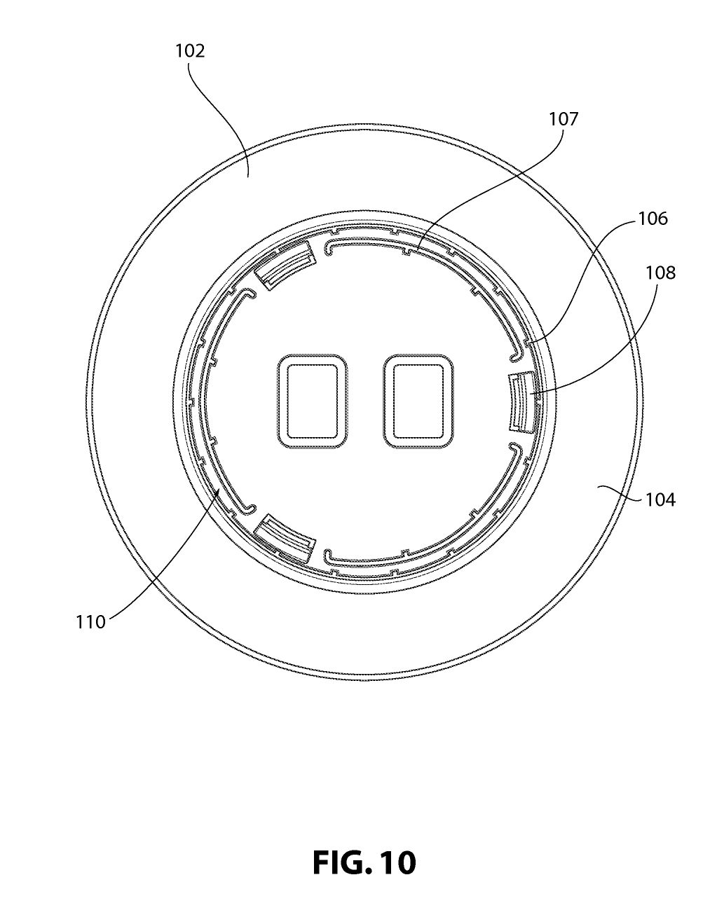

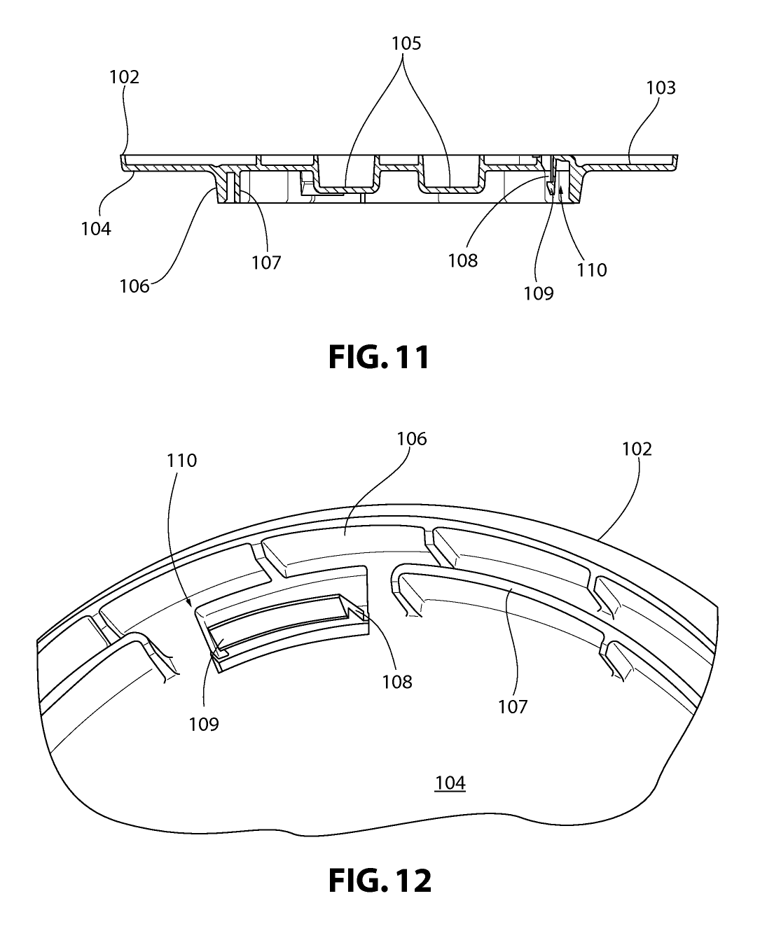

With reference to FIGS. 7-12, a cover assembly 100 for use as a rough-in cover is shown in accordance with another embodiment of the present invention. As shown in FIGS. 7 and 8, the cover assembly 100 is configured to be installed on the drain body 16 to surround the shank 15 prior to pouring of the concrete slab around the drain assembly. The cover assembly 100 includes a protector sleeve 101 and a cover 102. The cover 102 has a top surface 103 and a bottom 104, and is configured to be positioned over the shank 15. In particular, the cover 102 is positioned on and removably connected to the top of the shank 15.

The protector sleeve 101 is positioned between the bottom 104 of the cover 102 and the lid 22 of the drain body 16, and surrounding the shank 15. The protector sleeve 101 may be made from a flexible foam material so that it becomes compressed between the cover 102 and the drain body 16 during assembly and prevents the intrusion of concrete between the cover 102 and the drain body 16 to the shank 15 while concrete is poured around the drain body 16 and the cover assembly 100. In this manner, the cover 102 and the protector sleeve 101, in combination, define a void in the poured concrete slab to allow for installation and adjustment of the drain head assembly 11.

At least one projection 106, 107, 108 is disposed on the bottom 104 of the cover 102 for engaging the protector sleeve 101 to retain the position of the protector sleeve 101 and for engaging the shank 15 to removably connect the cover 102 to the shank 15. More specifically, the bottom 104 of the cover 102 includes an outer annular projection 106 forming a ring within the outer perimeter of the cover 102. The bottom 104 of the cover 102 also includes a plurality of inner arc-shaped projections 107 that are substantially concentric with the outer annular projection 106, and at least two inner flexible projections 108 that are substantially aligned with the diameter of the arc-shaped projections 107 and may also be arc-shaped concentric with the inner arc-shaped projections 107 and the outer annular projection 106. In this manner, the inner arc-shaped projections 107 and the inner flexible projections 108 form an inner ring within the diameter of the outer ring defined by the outer annular projection 106. The inner and outer rings define a channel 110 between them and are configured to engage the protector sleeve 101 to retain the protector sleeve 101 within the channel 110 in its position surrounding the shank 15, and to prevent the intrusion of poured concrete to the shank 15. The inner flexible projections 108 may include snap hooks 109 on the lower ends thereof and are configured to engage the top ring 20 of the shank 15 so that the cover 102 is removably connected to the top of the shank 15.

During construction, the drain body 16 and the threaded shank 15 are connected to the drain pipe within the subflooring. The rough-in cover assembly 100 is then installed onto the drain body 16 and over the threaded shank 15 such that the protector sleeve 101 is retained within the channel 110 formed between the projections 106, 107, 108 on the bottom 104 of the cover 102 and positioned between the bottom 104 of the cover 102 and the lid 22 of the drain body 16 to surround the threaded shank 15, and such that the cover 102 is removably connected to the threaded shank 15 via the engagement of the flexible projections 108 with snap hooks 109 and the top ring 20 of the threaded shank 15. Thus, the threaded shank 15 and the rough-in cover assembly 100 can be installed on to the drain body 16 and then adjusted to the required height, such that the top surface 103 of the rough-in cover 102 is positioned at a level flush with the intended height of the finished floor surface. The concrete slab can then be poured around the cover assembly 100 and the drain body 16, such that the cover assembly 100 defines a void in the finished floor surface that allows for installation and adjustment of the drain head assembly 11.

Once the concrete slab is poured and the finished floor surface completed, the rough-in cover assembly 100 can be removed from the threaded shank 15, which remains adjustable with respect to the drain body 16, and the strainer assembly of the strainer 12, upper frame 13, and lower frame 14 can be connected to the top of the threaded shank 15 in the manner discussed above. The drain head assembly 11 can be adjusted to the proper height such that the strainer 12 is flush with the finished floor surface. The top surface 103 of the cover 102 may include a notch or recess 105 to facilitate removal of the cover 102 from the finished concrete slab.

It is to be appreciated that the configuration of the cover 102 and the projections 106, 107, 108 may be altered in any manner known to be suitable to one having ordinary skill in the art so as to engage and retain the protector sleeve 101 between the cover 102 and the drain body 16, and to removably connect the cover 102 to the top of the threaded shank 15. The cover 102 may also be configured to have additional material thickness or the thickness may be increased by applying a layer of foam to the bottom 104 of the cover 102 so as to increase the size of the void in the poured concrete slab created by the cover 102 and facilitate access to the threaded shank 15 for installation and adjustment of the drain head assembly 11.

With reference to FIG. 8A, an alternative embodiment of the cover assembly 100 is shown. According to this embodiment, a protector sleeve 101a is provided with an increased material thickness and a reduced inside diameter as compared to the protector sleeve 101 discussed above with reference to FIGS. 8 and 9-12. As shown, the protector sleeve 101a is, therefore, wrapped tightly around the perimeter of the shank 15 to define the void in the finished concrete surface and to prevent infiltration of concrete to the threads or other connection features present on the shank 15. The engagement of the protector sleeve 101a tightly wrapped around the shank 15 serves to maintain the position of the protector sleeve 101a on the shank 15 during installation of the drain assembly 10 and pouring of the concrete slab. The protector sleeve 101a is not engaged within the channel 110 formed by the projections 106, 107, 108 formed on the bottom 104 of the cover 102. Instead, the protector sleeve 101a may be positioned on the shank 15 such that it abuts against the lowermost edges of the arc-shaped projections 107 extending from the bottom 104 of the cover 102 to prevent concrete from infiltrating to the engagement between the snap hooks 109 of the flexible projections 108 and the top ring 20 of the shank 15.

With reference to FIGS. 1-12, according to one embodiment of the present invention, a method of installing the drain assembly 10 in the finished floor surface 29 includes providing the drain assembly 10 described above; adjustably connecting the shank 15 of the drain head assembly 11 to the drain body 16; connecting the drain body 16 to a drain pipe such that the drain body 16 is in fluid communication with the drain pipe; connecting the cover 24, 102 to the shank 15 in the position over the shank 15; adjusting a height of the cover 24, 102 and the shank 15 with respect to the drain body 16 such that the cover 24, 102 is positioned at a level flush with an intended height of the finished floor surface 29; pouring a concrete slab around the cover 24, 102 and over the drain body 16 such that the cover 24, 102 at least partially defines a void in the poured concrete slab around the shank 15; removing the cover 24, 102 from the shank 15; and connecting the strainer assembly to the top of the shank 15. The method may further include providing the protector sleeve 101 and positioning the protector sleeve 101 between the bottom 104 of the cover 102 and the drain body 16, and surrounding the shank 15. The method may also further include adjusting the drain head assembly 11 such that a top of the strainer assembly is flush with the finished floor surface 29.

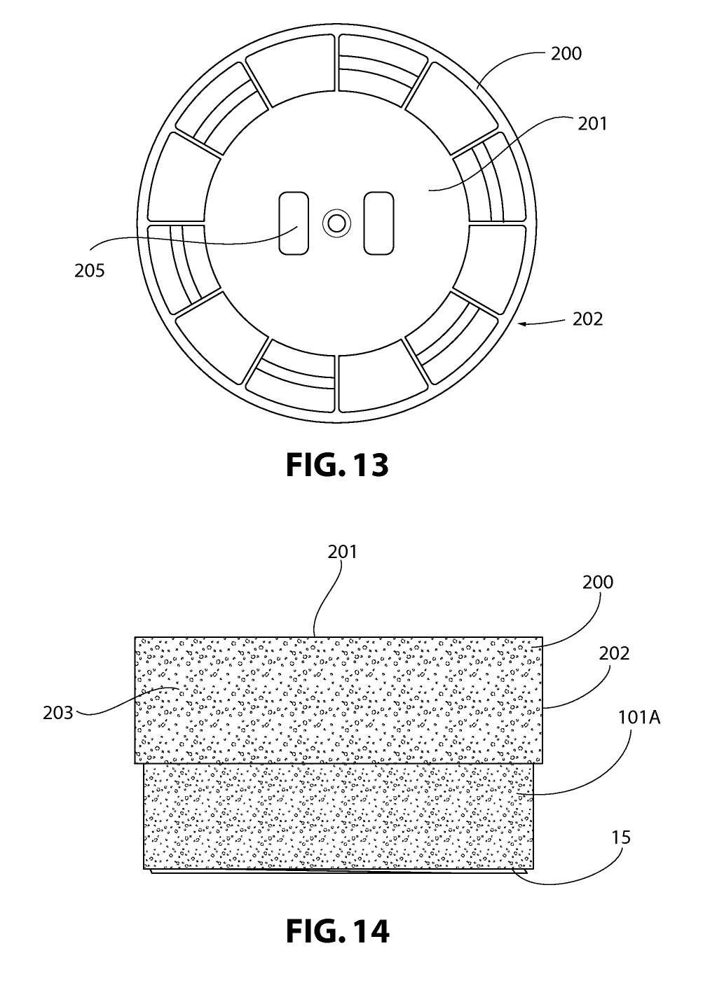

With reference to FIGS. 13-20, rough-in covers 200, 250 according to another embodiment of the present invention are shown. The rough-in covers 200, 250 are the same except as to the size defined at a top 201, 252 of each of the covers 200, 250, respectively. For example, the cover 200 may be a 5″ cover and the cover 250 may be a 6″ cover.

The rough-in covers 200, 250 are similar in structure and function to the cover 102 discussed above with reference to FIGS. 7-12 and are intended to be utilized with the drain assembly 10 discussed above with reference to FIGS. 1-8A in the same manner as the cover 102. Additionally, the covers 200, 250 may be utilized in a method of installing the drain assembly 10 analogous to the method discussed above with reference to FIGS. 1-12. Thus, the covers 200, 250 are configured to be operatively connected to the drain body 16 in a position over the drain body 16 and to at least partially define a void in a poured concrete slab over the drain body 16. In particular, as shown in FIGS. 14-16 and 18-20, the covers 200, 250 are removably connected to an adjustable member, such as the shank 15 of the drain head assembly 11, in the manner discussed above with reference to FIGS. 7-12. The covers 200, 250 each include a bottom similar to the bottom 104 of the cover 102, which includes a non-threaded attachment mechanism, for example, the above-described flexible projections 108 having snap hooks 109 that removably connects the covers 200, 250 to the shank 15 and, thus, operatively connects the cover 200, 250 to the drain body 16. Alternatively, the covers 200, 250 may be configured to connect directly to the drain body 16 via the non-threaded attachment mechanism to define the void over the drain body 16. The shank 15, as illustrated in FIGS. 14-16 and 18-20, includes the protector sleeve 101a disposed about its outer circumference in the manner discussed above with reference to FIG. 8A. Therefore, the covers 200, 250 are also configured to accommodate the presence of the protector sleeve 101a around the threaded portion of the shank 15, as discussed above.

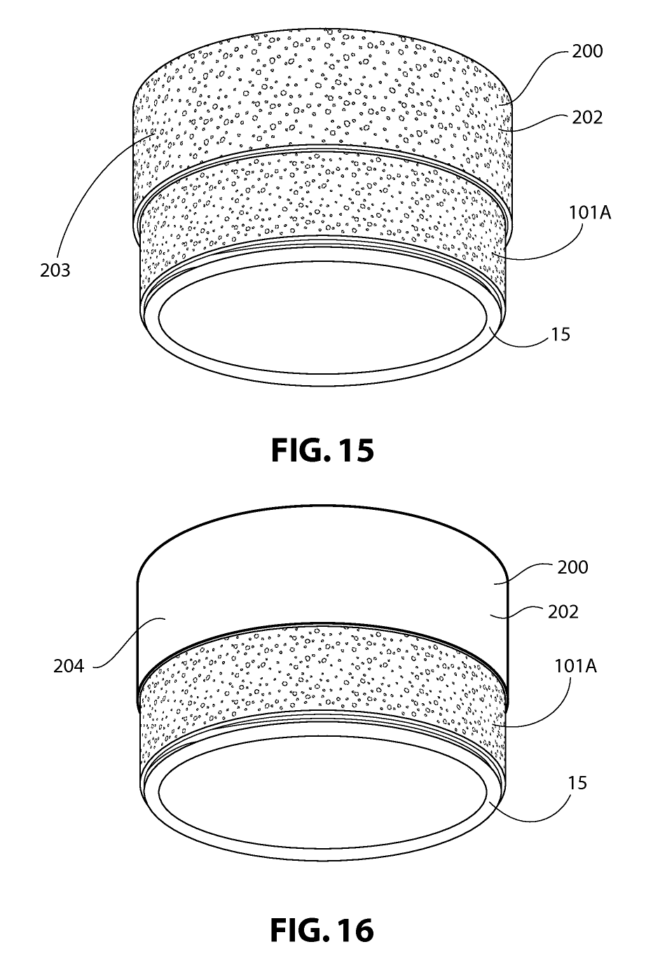

With reference to FIGS. 13-16, the cover 200 includes the top 201, a bottom, and at least one perimetrical sidewall 202 that defines at least one perimetrical surface of the cover 200. Specifically, the cover 200 has a cylindrical shape and the at least one perimetrical sidewall 202 defines a single circumferential surface extending from the top 201 of the cover 200, past the bottom of the cover 200, to a bottom edge. The top 201 of the cover 200 may include notches or recesses 205 defined therein to facilitate removal of the cover 200 from the finished concrete slab. A layer of release material 203, 204 is applied to the at least one perimetrical surface of the cover 200. The release material 203, 204 prevents poured concrete from adhering to the cover 200 as the concrete is poured and sets around the cover 200 to form the slab. According to one embodiment shown in FIGS. 14 and 15, the release material 203 may include a thin, self-adhesive layer of foam material 203 applied to the at least one perimetrical surface. The layer of foam material 203 acts as a release aid to assist in removing the cover 200 from the poured concrete by providing a barrier or cushion between the concrete and the at least one perimetrical surface of the cover 200 from attaching or adhering to the cover 200 so as to lock the cover 200 in place as the concrete sets or cures. According to another embodiment shown in FIG. 16, the release material 204 may include at least one layer of PTFE (polytetrafluoroethylene) tape that provides a slippery surface to the cover 200 so as to decrease the friction between the cover 200 and the poured concrete, and facilitate removal of the cover 200.

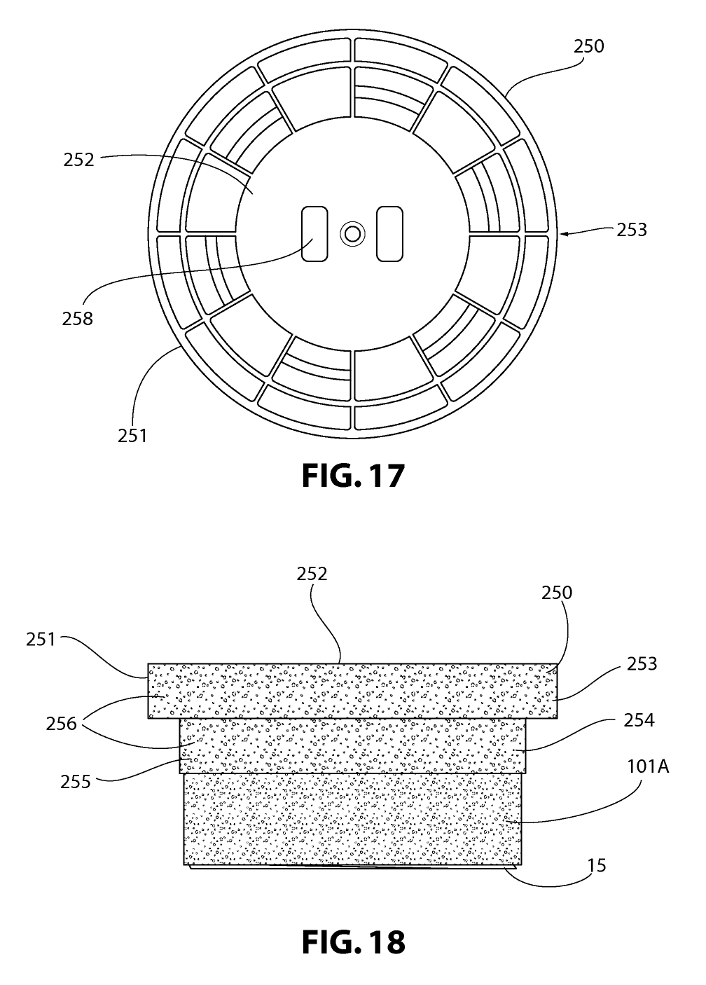

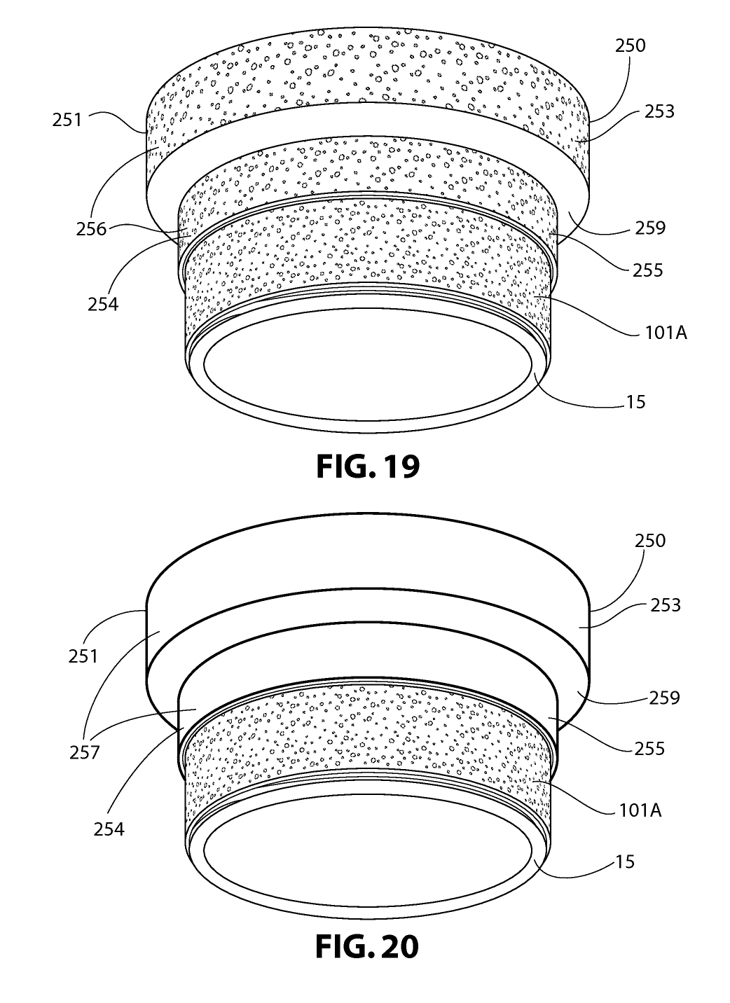

With reference to FIGS. 17-20, the cover 250 includes the top 252, a bottom, and at least one perimetrical sidewall 253, 255 that defines at least one perimetrical surface of the cover 250. Specifically, the cover 250 has a stepped cylindrical shape with a larger diameter upper portion 251 that includes at least one perimetrical sidewall 253 and a smaller diameter lower portion 254 that includes at least one perimetrical sidewall 255. The at least two perimetrical sidewalls 253, 255 define at least two perimetrical surfaces of the cover 250. The upper portion 251 has a single circumferential surface extending from the top 252 of the cover 250 to a transition surface 259 at the bottom of the upper portion 251, which connects the perimetrical sidewalls 253, 255. The lower portion 254 has a single circumferential surface extending from the transition surface 259, past the bottom of the cover 250, to a bottom edge. The top 252 of the cover 250 may include notches or recesses 205 defined therein to facilitate removal of the cover 250 from the finished concrete slab. As shown in FIGS. 18 and 19, a layer of release material 256 that includes foam material 256 may be applied to both of the at least two perimetrical surfaces defined by the perimetrical sidewalls 253, 255. Alternatively, as shown in FIG. 20, release material 257 applied to the at least two perimetrical surfaces may include PTFE tape 257. Although not illustrated, it is to be appreciated that the release material 256, 257 may also be applied to the transition surface 259 of the cover 250 to prevent concrete from adhering to the transition surface 259.

It is to be appreciated that any type of release material, such as another type of friction reducing tape or a chemical coating or material application, known to be suitable to those having ordinary skill in the art may be used in place of the above-discussed foam material and PTFE tape to prevent poured concrete from attaching or adhering to the cover 200, 250.

According to another alternative embodiment, an adhesive sticker (not shown) may be applied to the top 201, 252 of the cover 200, 250 for marking purposes and to prevent concrete and debris from being captured in the various pocket areas formed in the top 201, 252 of the cover 200, 250. The adhesive sticker should be easily punctured to permit access to the notches 205, 258 in the top 201, 252 of the cover 200, 250. It is to be appreciated that the other mechanisms may be provided to allow for marking of the cover 200, 250 and to prevent debris or concrete from becoming lodged in the top 201, 252 of the cover 200, 250. For instance, the cover 200, 250 could, alternatively, be formed with a smooth top surface.

While specific embodiments of the invention have been described in detail, it will be appreciated by those skilled in the art that various modifications and alternatives to those details could be developed in light of the overall teachings of the disclosure. The presently preferred embodiments described herein are meant to be illustrative only and not limiting as to the scope of the invention, which is to be given the full breadth of the appended claims and any and all equivalents thereof

1. A drain assembly, comprising:
a drain body configured to be connected to a drain pipe such that the drain body is in fluid communication with the drain pipe; and
a cover configured to be operatively connected to the drain body in a position over the drain body and to at least partially define a void in a poured concrete slab over the drain body,
wherein the cover includes a top, a bottom, and at least one perimetrical sidewall that defines at least one perimetrical surface of the cover, and at least one layer of a release material is applied to the at least one perimetrical surface of the cover to prevent poured concrete from adhering to the cover,
wherein the bottom of the cover includes a non-threaded attachment mechanism for operatively connecting the cover to the drain body, and
wherein the release material comprises a self-adhesive foam material.

2. The drain assembly according to claim 1, further comprising an adjustable member adjustably connected to the drain body,
wherein the cover is removably connected to the adjustable member by the non-threaded attachment mechanism.

3. The drain assembly according to claim 2, wherein the adjustable member comprises a shank of a drain head assembly of the drain assembly.

4. The drain assembly according to claim 1, wherein the non-threaded attachment mechanism on the bottom of the cover comprises at least one internal flexible hook depending from the bottom of the cover.

5-6. (canceled)

7. The drain assembly according to claim 1, wherein the cover comprises at least two perimetrical sidewalls having different diameters that define at least two perimetrical surfaces of the cover, and at least one layer of the release material is applied to each of the at least two perimetrical surfaces.

8. A rough-in cover for a drain assembly, comprising:
a top, a bottom, and at least one perimetrical sidewall that defines at least one perimetrical surface of the cover;
at least one layer of a release material applied to the at least one perimetrical surface of the cover; and
a non-threaded attachment mechanism for removably connecting the cover to a portion of the drain assembly,
wherein the cover is configured to be positioned over the drain assembly and to at least partially define a void in a poured concrete slab over the drain assembly,
wherein the release material comprises a self-adhesive foam material, and
wherein the at least one layer of release material is adapted to prevent poured concrete from adhering to the cover.

9. The rough-in cover according claim 8, wherein the non-threaded attachment mechanism is provided on the bottom of the cover.

10. The rough-in cover according to claim 9, wherein the non-threaded attachment mechanism on the bottom of the cover comprises at least one internal flexible hook depending from the bottom of the cover.

11-12. (canceled)

13. The rough-in cover according to claim 8, wherein the cover comprises at least two perimetrical sidewalls having different diameters that define at least two perimetrical surfaces of the cover, and at least one layer of the release material is applied to each of the at least two perimetrical surfaces.

14. A method of installing a drain assembly in a finished floor surface, comprising:
providing a drain assembly, the drain assembly comprising:
a drain body; and
a cover configured to be operatively connected to the drain body in a position over the drain body;
operatively connecting the cover to the drain body in the position over the drain body;
connecting the drain body to a drain pipe such that the drain body is in fluid communication with the drain pipe;
pouring a concrete slab around the cover and over the drain body such that the cover at least partially defines a void in the poured concrete slab over the drain body; and
removing the cover from the operative connection with the drain body,
wherein the cover includes a top, a bottom, and at least one perimetrical sidewall that defines at least one perimetrical surface of the cover, and at least one layer of a release material is applied to the at least one perimetrical surface of the cover to prevent the poured concrete from adhering to the cover,
wherein the release material comprises a self-adhesive foam material, and
wherein the bottom of the cover includes a non-threaded attachment mechanism for operatively connecting the cover to the drain body.

15. The method according to claim 14, wherein the drain assembly further comprises an adjustable member adjustably connected to the drain body,
wherein the step of operatively connecting the cover to the drain body includes removably connecting the cover to the adjustable member by the non-threaded attachment mechanism.

16. The method according to claim 15, further comprising:
adjusting a height of the cover and the adjustable member with respect to the drain body such that the cover is positioned at a level flush with an intended height of the finished floor surface.

17. The method according to claim 14, wherein the non-threaded attachment mechanism on the bottom of the cover comprises at least one internal flexible hook depending from the bottom of the cover.

18-19. (canceled)

20. The method according to claim 14, wherein the cover comprises at least two perimetrical sidewalls having different diameters that define at least two perimetrical surfaces of the cover, and at least one layer of the release material is applied to each of the at least two perimetrical surfaces.
